(19) United States
(12) Patent Application Publication
(10) Pub. No.: US 2020/0372806 A1
(43) Pub. Date: Nov. 26, 2020

(54) TRANSMITTING AERIAL VEHICLE POSITION INFORMATION

(71) Applicant: Lenovo (Beijing) Limited, Beijing (CN)

(72) Inventors: Haiming Wang, Beijing (CN); Jing Han, Beijing (CN); Lianhai Wu, Beijing (CN)

(21) Appl. No.: 16/638,400

(22) PCT Filed: Aug. 11, 2017
(86) PCT No.: PCT/CN2017/097259

§ 371 Date: Feb. 11, 2020

(51) Int. Cl. G08G 5/00; H04W 4/02

(52) U.S. Cl. CPC G08G 5/0004; H04W 4/02

(57) ABSTRACT

Apparatuses, methods, and systems are disclosed for transmitting aerial vehicle position information. One apparatus (200) includes a processor (202) that determines (702) whether a state of an aerial vehicle matches a predetermined state. The apparatus (200) includes a transmitter (210) that, in response to determining that the state of the aerial vehicle matches the predetermined state, broadcasts (704) position information of the aerial vehicle.

### FIELD

The subject matter disclosed herein relates generally to wireless communications and more particularly relates to transmitting aerial vehicle position information.

### BACKGROUND

The following abbreviations are herewith defined, at least some of which are referred to within the following description: Third Generation Partnership Project (“3GPP”), Positive-Acknowledgment (“ACK”), Binary Phase Shift Keying (“BPSK”), Clear Channel Assessment (“CCA”), Control Element (“CE”), Cyclic Prefix (“CP”), Cyclical Redundancy Check (“CRC”), Channel State Information (“CSI”), Common Search Space (“CSS”), Discrete Fourier Transform Spread (“DFTS”), Downlink Control Information (“DCI”), Downlink (“DL”), Downlink Pilot Time Slot (“DwPTS”), Enhanced Clear Channel Assessment (“eCCA”), Enhanced Mobile Broadband (“eMBB”), Evolved Node B (“eNB”), European Telecommunications Standards Institute (“ETSI”), Frame Based Equipment (“FBE”), Frequency Division Duplex (“FDD”), Frequency Division Multiple Access (“FDMA”), Frequency Division Orthogonal Cover Code (“FD-OCC”), Guard Period (“GP”), Hybrid Automatic Repeat Request (“HARQ”), Internet-of-Things (“IoT”), Licensed Assisted Access (“LAA”), Load Based Equipment (“LBE”), Listen-Before-Talk (“LBT”), Long Term Evolution (“LTE”), Multiple Access (“MA”), Medium Access Control (“MAC”), Modulation Coding Scheme (“MCS”), Machine Type Communication (“MTC”), Multiple Input Multiple Output (“MIMO”), Multi User Shared Access (“MUSA”), Narrowband (“NB”), Negative-Acknowledgment (“NACK”) or (“NAK”), Next Generation Node B (“gNB”), Non-Orthogonal Multiple Access (“NOMA”), Orthogonal Frequency Division Multiplexing (“OFDM”), Primary Cell (“PCell”), Physical Broadcast Channel (“PBCH”), Physical Downlink Control Channel (“PDCCH”), Physical Downlink Shared Channel (“PDSCH”), Pattern Division Multiple Access (“PDMA”), Physical Hybrid ARQ Indicator Channel (“PHICH”), Physical Random Access Channel (“PRACH”), Physical Resource Block (“PRB”), Physical Uplink Control Channel (“PUCCH”), Physical Uplink Shared Channel (“PUSCH”), Quality of Service (“QoS”), Quadrature Phase Shift Keying (“QPSK”), Radio Resource Control (“RRC”), Random Access Procedure (“RACH”), Random Access Response (“RAR”), Radio Network Temporary Identifier (“RNTI”), Reference Signal (“RS”), Remaining Minimum System Information (“RMSI”), Resource Spread Multiple Access (“RSMA”), Round Trip Time (“RTT”), Receive (“RX”), Sparse Code Multiple Access (“SCMA”), Scheduling Request (“SR”), Single Carrier Frequency Division Multiple Access (“SC-FDMA”), Secondary Cell (“SCell”), Shared Channel (“SCH”), Signal-to-Interference-Plus-Noise Ratio (“SINR”), System Information Block (“SIB”), Synchronization Signal (“SS”), Transport Block (“TB”), Transport Block Size (“TBS”), Time-Division Duplex (“TDD”), Time Division Multiplex (“TDM”), Time Division Orthogonal Cover Code (“TD-OCC”), Transmission Time Interval (“TTI”), Transmit (“TX”), Uplink Control Information (“UCI”), User Entity/Equipment (Mobile Terminal) (“UE”), Uplink (“UL”), Universal Mobile Telecommunications System (“UMTS”), Uplink Pilot Time Slot (“UpPTS”), Ultra-reliability and Low-latency Communications (“URLLC”), and Worldwide Interoperability for Microwave Access (“WiMAX”). As used herein, “HARQ-ACK” may represent collectively the Positive Acknowledge (“ACK”) and the Negative Acknowledge (“NACK”). ACK means that a TB is correctly received while NACK (or NAK) means a TB is erroneously received.

In certain wireless communications networks, aerial vehicles may be present. In such networks, flight paths of aerial vehicles may overlap thereby causing collisions between the aerial vehicles.

### BRIEF SUMMARY

Apparatuses for transmitting aerial vehicle position information are disclosed. Methods and systems also perform the functions of the apparatus. In one embodiment, the apparatus includes a processor that determines whether a state of an aerial vehicle matches a predetermined state. In certain embodiments, the apparatus includes a transmitter that, in response to determining that the state of the aerial vehicle matches the predetermined state, broadcasts position information of the aerial vehicle.

In one embodiment, the predetermined state of the aerial vehicle includes the aerial vehicle having an established cellular network connection. In a further embodiment, the predetermined state of the aerial vehicle includes the aerial vehicle having an established cellular network connection and an altitude greater than a threshold altitude. In certain embodiments, the predetermined state of the aerial vehicle includes the aerial vehicle having an established cellular network connection, an altitude greater than a threshold altitude, and a velocity greater than a threshold velocity.

In various embodiments, the transmitter broadcasts the position information using a broadcast interval configuration, a broadcast power configuration, or some combination thereof. In some embodiments, the broadcast interval configuration is adjustable during operation. In one embodiment, the broadcast interval configuration is adjusted by radio resource control signaling, medium access control element signaling, physical layer signaling, cell level system information block signaling, or some combination thereof. In a further embodiment, the broadcast interval configuration includes a first set of broadcast interval parameters for the aerial vehicle being on-ground and a second set of broadcast interval parameters for the aerial vehicle being airborne. In certain embodiments, the first set of broadcast interval parameters includes a large interval and the second set of broadcast interval parameters includes a small interval.

In various embodiments, the processor determines to use the first set of broadcast interval parameters for the aerial vehicle or the second set of broadcast interval parameters for the aerial vehicle based on the state of the aerial vehicle. In some embodiments, the broadcast interval configuration is based on a velocity of the aerial vehicle, an altitude of the aerial vehicle, aerial traffic, the state of the aerial vehicle, or some combination thereof. In one embodiment, the broadcast interval configuration includes an interval parameter used in response to a velocity of the aerial vehicle being within a velocity range and an altitude of the aerial vehicle being within an altitude range. In a further embodiment, the broadcast interval configuration includes a large interval parameter used in response to aerial vehicles in a predetermined area being less than a threshold number and a small interval parameter used in response to aerial vehicles in the predetermined area being greater than the threshold number.

In certain embodiments, the broadcast interval configuration includes a large interval parameter used in response to the aerial vehicle hovering. In various embodiments, the broadcast interval configuration includes a default broadcast interval configuration, and a received broadcast interval configuration overrides the default broadcast interval configuration. In some embodiments, in response to the aerial vehicle hovering, a list of hovering aerial vehicles is broadcast. In one embodiment, the processor broadcasts a position determination methodology, and the position determination methodology implicitly indicates a position accuracy.

In certain embodiments, the processor broadcasts a position accuracy and a confidence level with the position information. In various embodiments, the processor broadcasts a confidence level with the position information in response to a network requirement. In some embodiments, the processor broadcasts a confidence level with the position information, wherein the confidence level is mapped to a position accuracy. In one embodiment, in response to not broadcasting a position accuracy, a default position accuracy is used.

In certain embodiments, the processor broadcasts aerial vehicle assistance information. In various embodiments, the apparatus includes a receiver that receives information indicating to the aerial vehicle to disable broadcasting the position information. In some embodiments, the processor broadcasts absolute position information at a large interval and broadcasting delta position information between large interval broadcasting. In one embodiment, a transmission power for broadcasting the position information is changed based on a capability of the aerial vehicle, a state of the aerial vehicle, aerial traffic, or some combination thereof.

A method for transmitting aerial vehicle position information, in one embodiment, includes determining whether a state of an aerial vehicle matches a predetermined state. In some embodiments, the method includes, in response to determining that the state of the aerial vehicle matches the predetermined state, broadcasting position information of the aerial vehicle.

In one embodiment, an apparatus for receiving aerial vehicle position information includes a receiver that receives broadcast position information of an aerial vehicle in response to the aerial vehicle determining that a state of the aerial vehicle matches a predetermined state.

A method for receiving aerial vehicle position information, in one embodiment, includes receiving broadcast position information of an aerial vehicle in response to the aerial vehicle determining that a state of the aerial vehicle matches a predetermined state.

### BRIEF DESCRIPTION OF THE DRAWINGS

A more particular description of the embodiments briefly described above will be rendered by reference to specific embodiments that are illustrated in the appended drawings.

Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for transmitting aerial vehicle position information;

FIG. 2 is a schematic block diagram illustrating one embodiment of an apparatus that may be used for transmitting and/or receiving aerial vehicle position information;

FIG. 3 is a schematic block diagram illustrating one embodiment of an apparatus that may be used for receiving aerial vehicle position information;

FIG. 4 is a schematic block diagram illustrating one embodiment of a trigger condition for transmitting aerial vehicle position information;

FIG. 5 is a schematic block diagram illustrating another embodiment of a trigger condition for transmitting aerial vehicle position information;

FIG. 6 is a schematic block diagram illustrating a further embodiment of a trigger condition for transmitting aerial vehicle position information;

FIG. 7 is a schematic flow chart diagram illustrating one embodiment of a method for transmitting aerial vehicle position information; and

FIG. 8 is a schematic flow chart diagram illustrating one embodiment of a method for receiving aerial vehicle position information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

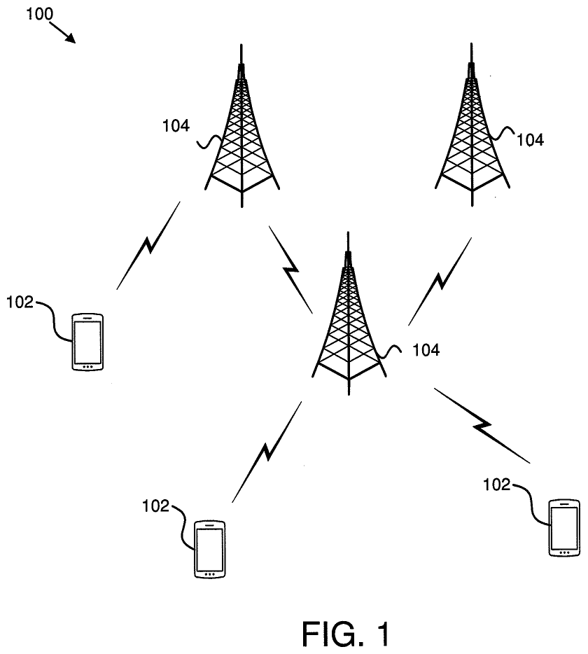

FIG. 1 depicts an embodiment of a wireless communication system 100 for transmitting aerial vehicle position information. In one embodiment, the wireless communication system 100 includes remote units 102 and base units 104. Even though a specific number of remote units 102 and base units 104 are depicted in FIG. 1, one of skill in the art will recognize that any number of remote units 102 and base units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the base units 104 via UL communication signals.

The base units 104 may be distributed over a geographic region. In certain embodiments, a base unit 104 may also be referred to as an access point, an access terminal, a base, a base station, a Node-B, an eNB, a gNB, a Home Node-B, a relay node, a device, a core network, an aerial server, or by any other terminology used in the art. The base units 104 are generally part of a radio access network that includes one or more controllers communicably coupled to one or more corresponding base units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 3GPP protocol, wherein the base unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

The base units 104 may serve a number of remote units 102 within a serving area, for example, a cell or a cell sector via a wireless communication link. The base units 104 transmit DL communication signals to serve the remote units 102 in the time, frequency, and/or spatial domain.

In one embodiment, a remote unit 102 (e.g., remote unit 102 that is part of an aerial vehicle) may determine whether a state of an aerial vehicle matches a predetermined state. In some embodiments, the remote unit 102 may, in response to determining that the state of the aerial vehicle matches the predetermined state, broadcast position information of the aerial vehicle. Accordingly, a remote unit 102 may be used for receiving aerial vehicle position information.

In one embodiment, a base unit 104 (e.g., eNB) and/or a remote unit 102 may receive broadcast position information of an aerial vehicle in response to the aerial vehicle determining that a state of the aerial vehicle matches a predetermined state. Accordingly, a base unit 104 and/or a remote unit 102 may be used for receiving aerial vehicle position information.

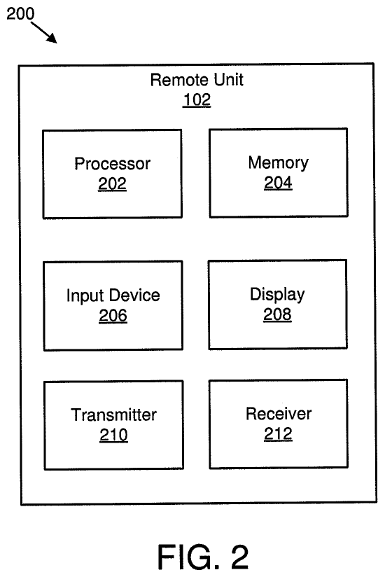

FIG. 2 depicts one embodiment of an apparatus 200 that may be used for transmitting and/or receiving aerial vehicle position information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. In one embodiment, the processor 202 may be used to determine whether a state of an aerial vehicle matches a predetermined state. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to a predetermined state. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the base unit 104 and the receiver 212 is used to receive DL communication signals from the base unit 104. In various embodiments, the transmitter 210 may be used to, in response to determining that the state of the aerial vehicle matches the predetermined state, broadcasting position information of the aerial vehicle. In some embodiments, the receiver 212 may be used to receive broadcast position information of an aerial vehicle in response to the aerial vehicle determining that a state of the aerial vehicle matches a predetermined state. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

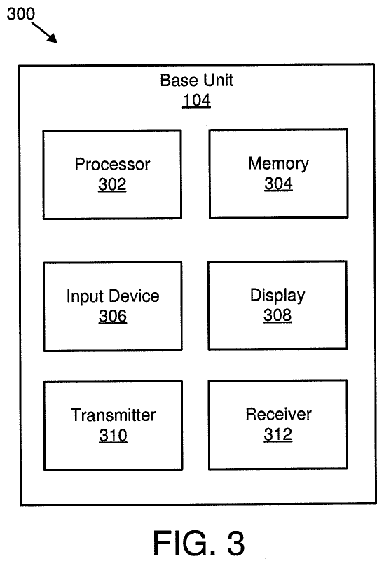

FIG. 3 depicts one embodiment of an apparatus 300 that may be used for receiving aerial vehicle position information. The apparatus 300 includes one embodiment of the base unit 104. Furthermore, the base unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the receiver 312 may receive broadcast position information of an aerial vehicle in response to the aerial vehicle determining that a state of the aerial vehicle matches a predetermined state. Although only one transmitter 310 and one receiver 312 are illustrated, the base unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

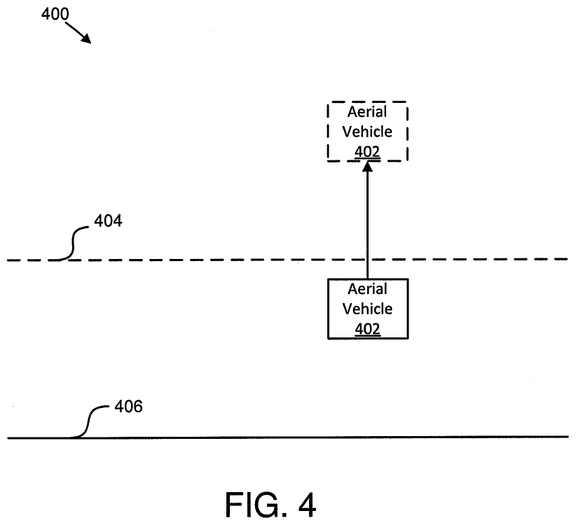

FIG. 4 is a schematic block diagram illustrating one embodiment of a trigger condition 400 for transmitting aerial vehicle position information. In certain embodiments, the trigger condition 400 of an aerial vehicle 402 may be that the aerial vehicle 402 passes a threshold altitude 404. In various embodiments, the threshold altitude may be relative to a ground altitude 406. In some embodiments, aerial vehicle position information is transmitted in response to the aerial vehicle 402 transitioning from a first altitude below the threshold altitude 404 to a second altitude above the threshold altitude 404, as shown by the aerial vehicle 402 illustrated with a solid line at the first altitude below the threshold altitude 404 and the aerial vehicle 402 illustrated with a dashed line at the second altitude above the threshold altitude 404. In one example, the threshold altitude 404 is approximately 5 meters; however, the threshold altitude 404 may be any suitable altitude. In this example, in response to the aerial vehicle 402 having an altitude higher than 5 meters, the aerial vehicle 402 may transmit vehicle position information, and, in response to the aerial vehicle having an altitude less than 5 meters, the aerial vehicle 402 may not transmit vehicle position information.

In one embodiment, the aerial vehicle 402 may broadcast (e.g., transmit) vehicle position information solely in response to the aerial vehicle 402 accessing a cellular network. In such an embodiment, accessing the cellular network may include either the aerial vehicle 402 being in an RRC connected state or an RRC idle state. In various embodiments, the aerial vehicle 402 may broadcast vehicle position information automatically once the trigger condition (e.g., accessing the cellular network) is detected. In certain embodiments, the aerial vehicle 402 may broadcast vehicle position information regularly with a defined interval and/or power. In such embodiments, the aerial vehicle 402 may broadcast the vehicle position information regardless of a status of the aerial vehicle 402. As used herein, position information may include a longitude, a latitude, an altitude, a geospatial position, a velocity, and/or other position related information. Moreover, a defined interval as used herein may be a time period between each broadcast of vehicle position information. Furthermore, as used herein, a status of the aerial vehicle 402 may refer to being in an RRC connection mode, being in an idle mode, being in a data transmission mode, being in a control transmission mode, ascending, descending, being in a risk area, being in a safe area, and so forth.

In some embodiments, the aerial vehicle 402 may broadcast vehicle position information in response to both of: the aerial vehicle 402 accessing a cellular network; and the altitude of the aerial vehicle 402 being greater than (e.g., above) the threshold altitude 404. In various embodiments, the aerial vehicle 402 may broadcast vehicle position information automatically once the trigger condition (e.g., both of accessing the cellular network and the altitude of the aerial vehicle 402 being greater than the threshold altitude 404) is detected. In certain embodiments, the aerial vehicle 402 may broadcast vehicle position information regularly with a defined interval and/or power.

In some embodiments, the aerial vehicle 402 may broadcast vehicle position information in response to some combination of: the aerial vehicle 402 accessing a cellular network; the altitude of the aerial vehicle 402 being greater than (e.g., above) the threshold altitude 404; and a velocity of the aerial vehicle 402 being greater than (e.g., above) a threshold velocity. In various embodiments, the aerial vehicle 402 may broadcast vehicle position information automatically once the trigger condition (e.g., all of accessing the cellular network, the altitude of the aerial vehicle 402 being greater than the threshold altitude 404, and the velocity of the aerial vehicle 402 being greater than the threshold velocity) is detected. In certain embodiments, the aerial vehicle 402 may broadcast vehicle position information regularly with a defined interval and/or power.

In various embodiments, the aerial vehicle 402 may broadcast vehicle position information adaptively (e.g., the vehicle position information may be broadcast with different characteristics based on properties of the aerial vehicle 402). In certain embodiments, the aerial vehicle 402 may broadcast vehicle position information differently based on properties corresponding to the aerial vehicle 402. For example, in one embodiment, the aerial vehicle 402 may have one set of parameters for an on-ground aerial vehicle and another set of parameters for a flying aerial vehicle. In some embodiments, a set of parameters for an on-ground aerial vehicle may include transmitting vehicle position information at a large interval (e.g., greater than a predetermined time period between transmissions of vehicle position information). In various embodiments, a set of parameters for a flying aerial vehicle may include transmitting vehicle position information at a small interval (e.g., less than a predetermined time period between transmissions of vehicle position information). In certain embodiments, the aerial vehicle 402 determines which set of parameters to use based on properties of the aerial vehicle 402 (e.g., altitude, velocity, etc.).

In some embodiments, the aerial vehicle 402 may broadcast vehicle position information differently based on a flying velocity, a flying altitude, an aerial traffic condition, and/or a status of the aerial vehicle 402. For example, in certain embodiments, in response to the aerial vehicle 402 having a specific velocity and a specific altitude range, a predetermined transmission interval parameter may be used. In one embodiment, a table or set of information may indicate the predetermined transmission interval parameter corresponding to the specific velocity and the specific altitude range. In such an embodiment, the table or set of information may be known to the aerial vehicle 402 and to a base unit 104.

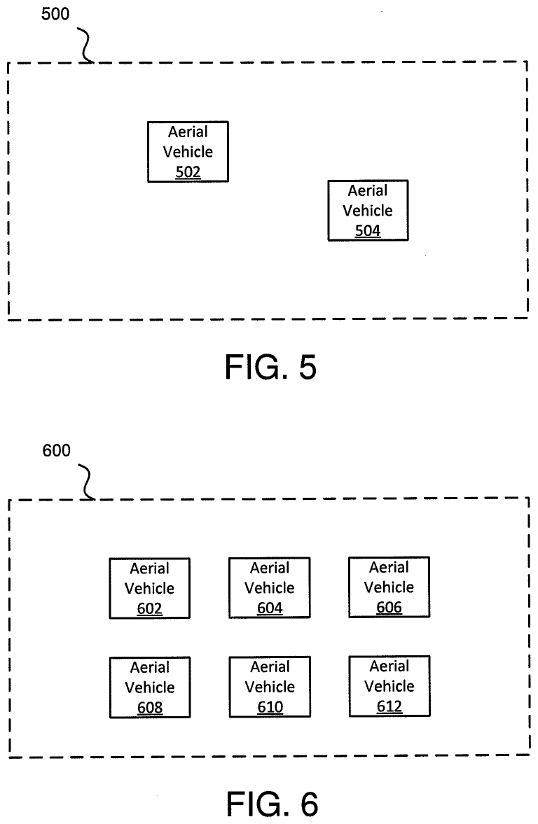

FIG. 5 is a schematic block diagram illustrating another embodiment of a trigger condition for transmitting aerial vehicle position information. In certain embodiments, a predetermined area 500 may include aerial vehicles 502 and 504. In such embodiments, the predetermined area 500 may be sparsely populated (e.g., less than a predetermined ratio formed by dividing the aerial vehicles in the predetermined area 500 by the predetermined area 500). In various embodiments, in response to the predetermined area 500 being sparsely populated (e.g., a trigger condition), the aerial vehicle 402 may broadcast vehicle position information differently from the predetermined area 500 being densely populated. For example, in response to the predetermined area 500 being sparsely populated, the aerial vehicle 402 may not broadcast vehicle position information, may broadcast vehicle position information at a large interval, and/or may broadcast a change in position information. In some embodiments, by transmitting vehicle position information at a large interval, interference may be reduced and/or transmission power may be reduced compared to configurations that transmit vehicle position information at a small interval.

FIG. 6 is a schematic block diagram illustrating a further embodiment of a trigger condition for transmitting aerial vehicle position information. In certain embodiments, a predetermined area 600 may include aerial vehicles 602, 604, 606, 608, 610, and 612. In such embodiments, the predetermined area 600 may be densely populated. In various embodiments, in response to the predetermined area 600 being densely populated (e.g., a trigger condition), the aerial vehicle 402 may broadcast vehicle position information differently from the predetermined area 600 being sparsely populated. For example, in response to the predetermined area 600 being densely populated, the aerial vehicle 402 may broadcast vehicle position information and/or may broadcast vehicle position information at a small interval.

Returning to FIG. 4, in certain embodiments, the aerial vehicle 402 may determine its position using one or more positioning methods. For example, the aerial vehicle 402 may determine its position using a global navigation satellite system (“GNSS”) based positioning (e.g., global positioning system “GPS”), a radio access technology (“RAT”) based positioning, and/or an inertial navigation system positioning.

In various embodiments, in response to the aerial vehicle 402 being in a hover state (e.g., a state in which the aerial vehicle 402 is in the air at substantially the same position for a predetermined period of time), the position of the aerial vehicle 402 may not change over the predetermined period of time. Accordingly, in such embodiments, the aerial vehicle 402 may broadcast vehicle position information at a large interval. In some embodiments, a base unit 104 may broadcast a list of hovering aerial vehicles to a cellular network so that aerial vehicles in the vicinity of the hovering vehicles may be informed to not expect frequent vehicle position information reporting from the hovering vehicles.

In certain embodiments, an interval for transmitting vehicle position information may be dynamically changed via RRC signaling, MAC CE signaling, physical layer signaling, and/or SIB signaling (e.g., cell-level SIB signaling). In some embodiments, base unit 104 and/or network signaling interval parameters may override default interval parameters.

In various embodiments, remote unit 102 assistance information may be reported to assist a base unit 104 in making a broadcasting parameter decision. The assistance information may include: a planned flight area and/or path; a planned maximum flight altitude; a planned maximum flying velocity (e.g., vertical and/or horizontal speed); an estimated duration of flight; a type of application and/or services; a remaining battery life; a sense and/or avoidance capability (e.g., an availability of a camera, an availability of ultrasonic equipment, an availability of other equipment); a preferred position broadcasting interval and/or power level; an operation mode (e.g., automatic flight and/or hand-controlled flight); and/or other aerial vehicle specific parameters.

In certain embodiments, positioning accuracy may be associated with a used positioning method (e.g., GNSS, RAT, inertial navigation). The association may be indicated explicitly and/or implicitly. In some embodiments, implicit association may be performed using a preconfigured default value. Based on the used positioning method, the relevant position accuracy may be known implicitly. For example, an accuracy value N may be used in response to GNSS being used. However, an accuracy value M may be used in response to RAT based positioning method being used. In various embodiments, positioning accuracy information may be reported and/or broadcast explicitly together with position information and a confidence level. In various embodiments, a confidence level may be a fixed value (e.g., 95%) defined in a specification, the confidence level may be required by network based on a real operation situation via signaling, and/or an aerial vehicle may associate a confidence level with an estimated position accuracy (e.g., there may be a set of mapping values between confidence levels and estimated position accuracies). In some embodiments, if a position accuracy is not available, then a base unit 104 and/or surrounding aerial vehicles may assume default position accuracy information. In various embodiments, neighboring aerial vehicles may use a received position accuracy to decide its own behavior (e.g., decent, rise, or hover).

In some embodiments, such as for safety purposes, position broadcasting may be disabled by a cellular network. In various embodiments, position broadcasting may be disabled by: setting a position reporting interval to be an infinite value; and/or transmitting explicit “STOP” signaling via RRC, MAC, and/or physical layer signaling from a base unit 104 to a remote unit 102. In certain embodiments, to reduce signaling overhead, absolute position information may be broadcasted in a large interval and only changed position information may be broadcasted in between the large intervals. In some embodiments, a used transmission power may be changed for the position broadcasting message based on: aerial vehicle capability, a real-time aerial vehicle status (e.g., flying velocity and/or flying altitude); and/or surrounding aerial traffic conditions.

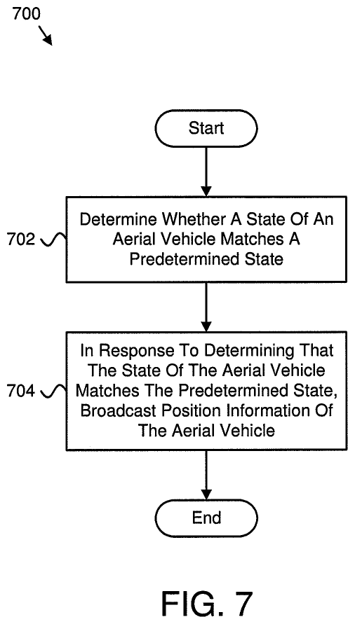

FIG. 7 is a schematic flow chart diagram illustrating one embodiment of a method 700 for transmitting aerial vehicle position information. In some embodiments, the method 700 is performed by an apparatus, such as the remote unit 102 (e.g., remote unit 102 that is part of an aerial vehicle). In certain embodiments, the method 700 may be performed by a processor executing program code, for example, a microcontroller, a microprocessor, a CPU, a GPU, an auxiliary processing unit, a FPGA, or the like.

The method 700 may include determining 702 whether a state of an aerial vehicle matches a predetermined state. In some embodiments, the method 700 includes, in response to determining that the state of the aerial vehicle matches the predetermined state, broadcasting 704 position information of the aerial vehicle.

In one embodiment, the predetermined state of the aerial vehicle includes the aerial vehicle having an established cellular network connection. In a further embodiment, the predetermined state of the aerial vehicle includes the aerial vehicle having an established cellular network connection and an altitude greater than a threshold altitude. In certain embodiments, the predetermined state of the aerial vehicle includes the aerial vehicle having an established cellular network connection, an altitude greater than a threshold altitude, and a velocity greater than a threshold velocity.

In various embodiments, the method 700 includes broadcasting the position information using a broadcast interval configuration, a broadcast power configuration, or some combination thereof. In some embodiments, the broadcast interval configuration is adjustable during operation. In one embodiment, the broadcast interval configuration is adjusted by radio resource control signaling, medium access control control element signaling, physical layer signaling, cell level system information block signaling, or some combination thereof. In a further embodiment, the broadcast interval configuration includes a first set of broadcast interval parameters for the aerial vehicle being on-ground and a second set of broadcast interval parameters for the aerial vehicle being airborne. In certain embodiments, the first set of broadcast interval parameters includes a large interval and the second set of broadcast interval parameters includes a small interval.

In various embodiments, the method 700 includes determining to use the first set of broadcast interval parameters for the aerial vehicle or the second set of broadcast interval parameters for the aerial vehicle based on the state of the aerial vehicle. In some embodiments, the broadcast interval configuration is based on a velocity of the aerial vehicle, an altitude of the aerial vehicle, aerial traffic, the state of the aerial vehicle, or some combination thereof. In one embodiment, the broadcast interval configuration includes an interval parameter used in response to a velocity of the aerial vehicle being within a velocity range and an altitude of the aerial vehicle being within an altitude range. In a further embodiment, the broadcast interval configuration includes a large interval parameter used in response to aerial vehicles in a predetermined area being less than a threshold number and a small interval parameter used in response to aerial vehicles in the predetermined area being greater than the threshold number.

In certain embodiments, the broadcast interval configuration includes a large interval parameter used in response to the aerial vehicle hovering. In various embodiments, the broadcast interval configuration includes a default broadcast interval configuration, and a received broadcast interval configuration overrides the default broadcast interval configuration.

In some embodiments, in response to the aerial vehicle hovering, a list of hovering aerial vehicles is broadcast. In one embodiment, the method 700 includes broadcasting a position determination methodology, and the position determination methodology implicitly indicates a position accuracy.

In certain embodiments, the method 700 includes broadcasting a position accuracy and a confidence level with the position information. In various embodiments, the method 700 includes broadcasting a confidence level with the position information in response to a network requirement. In some embodiments, the method 700 includes broadcasting a confidence level with the position information, wherein the confidence level is mapped to a position accuracy. In one embodiment, in response to not broadcasting a position accuracy, a default position accuracy is used.

In certain embodiments, the method 700 includes broadcasting aerial vehicle assistance information. In various embodiments, the method 700 includes receiving information indicating to the aerial vehicle to disable broadcasting the position information. In some embodiments, the method 700 includes broadcasting absolute position information at a large interval and broadcasting delta position information between large interval broadcasting. In one embodiment, a transmission power for broadcasting the position information is changed based on a capability of the aerial vehicle, a state of the aerial vehicle, aerial traffic, or some combination thereof.

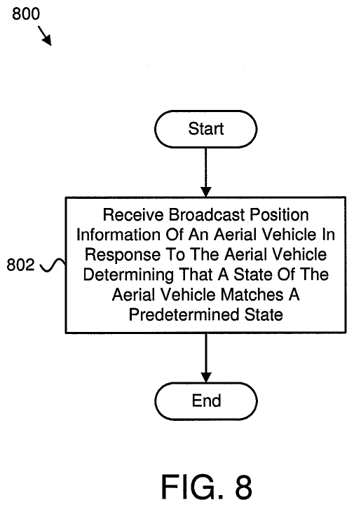

FIG. 8 is a schematic flow chart diagram illustrating one embodiment of a method 800 for receiving aerial vehicle position information. In some embodiments, the method 800 is performed by an apparatus, such as the base unit 104 (e.g., eNB) or the remote unit 102 (e.g., an aerial vehicle including the remote unit 102). In certain embodiments, the method 800 may be performed by a processor executing program code, for example, a microcontroller, a microprocessor, a CPU, a GPU, an auxiliary processing unit, a FPGA, or the like.

The method 800 may include receiving 802 broadcast position information of an aerial vehicle in response to the aerial vehicle determining that a state of the aerial vehicle matches a predetermined state.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
determining whether a state of an aerial vehicle matches a predetermined state; and
in response to determining that the state of the aerial vehicle matches the predetermined state, broadcasting position information of the aerial vehicle.

2. (canceled)

3. (canceled)

4. The method of claim 1, wherein the predetermined state of the aerial vehicle comprises the aerial vehicle having an established cellular network connection, an altitude greater than a threshold altitude, a velocity greater than a threshold velocity, or some combination thereof.

5. The method of claim 1, wherein broadcasting the position information of the aerial vehicle comprises broadcasting the position information using a broadcast interval configuration, a broadcast power configuration, or some combination thereof.

6. The method of claim 5, wherein the broadcast interval configuration is adjustable during operation, wherein the broadcast interval configuration is adjusted by radio resource control signaling, medium access control element signaling, physical layer signaling, cell level system information block signaling, or some combination thereof.

7. (canceled)

8. The method of claim 5, wherein the broadcast interval configuration comprises a first set of broadcast interval parameters for the aerial vehicle being on-ground and a second set of broadcast interval parameters for the aerial vehicle being airborne.

9. The method of claim 8, wherein the first set of broadcast interval parameters comprises a large interval and the second set of broadcast interval parameters comprises a small interval.

10. The method of claim 8, further comprising determining to use the first set of broadcast interval parameters for the aerial vehicle or the second set of broadcast interval parameters for the aerial vehicle based on the state of the aerial vehicle.

11. The method of claim 5, wherein the broadcast interval configuration is based on a velocity of the aerial vehicle, an altitude of the aerial vehicle, aerial traffic, the state of the aerial vehicle, or some combination thereof.

12. The method of claim 5, wherein the broadcast interval configuration comprises an interval parameter used in response to a velocity of the aerial vehicle being within a velocity range and an altitude of the aerial vehicle being within an altitude range.

13. The method of claim 5, wherein the broadcast interval configuration comprises a large interval parameter used in response to aerial vehicles in a predetermined area being less than a threshold number and a small interval parameter used in response to aerial vehicles in the predetermined area being greater than the threshold number.

14. The method of claim 5, wherein the broadcast interval configuration comprises a large interval parameter used in response to the aerial vehicle hovering.

15. The method of claim 5, wherein the broadcast interval configuration comprises a default broadcast interval configuration, and a received broadcast interval configuration overrides the default broadcast interval configuration.

16. The method of claim 1, wherein, in response to the aerial vehicle hovering, a list of hovering aerial vehicles is broadcast.

17. The method of claim 1, further comprising broadcasting a position determination methodology, wherein the position determination methodology implicitly indicates a position accuracy.

18. The method of claim 1, further comprising broadcasting a position accuracy and a confidence level with the position information.

19. The method of claim 1, further comprising broadcasting a confidence level with the position information in response to a network requirement.

20. The method of claim 1, further comprising broadcasting a confidence level with the position information, wherein the confidence level is mapped to a position accuracy.

21. The method of claim 1, wherein, in response to not broadcasting a position accuracy, a default position accuracy is used.

22. The method of claim 1, further comprising broadcasting aerial vehicle assistance information.

23. The method of claim 1, further comprising receiving information indicating to the aerial vehicle to disable broadcasting the position information.

24. The method of claim 1, wherein broadcasting the position information comprises broadcasting absolute position information at a large interval and broadcasting delta position information between large interval broadcasting.

25. The method of claim 1, wherein a transmission power for broadcasting the position information is changed based on a capability of the aerial vehicle, a state of the aerial vehicle, aerial traffic, or some combination thereof.

26. An apparatus comprising:
a processor that determines whether a state of an aerial vehicle matches a predetermined state; and
a transmitter that, in response to determining that the state of the aerial vehicle matches the predetermined state, broadcasts position information of the aerial vehicle.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method comprising:
receiving broadcast position information of an aerial vehicle in response to the aerial vehicle determining that a state of the aerial vehicle matches a predetermined state.

52. An apparatus comprising:
a receiver that receives broadcast position information of an aerial vehicle in response to the aerial vehicle determining that a state of the aerial vehicle matches a predetermined state.
